(19) United States
(12) Patent Application Publication
(10) Pub. No.: US 2018/0167487 A1
(43) Pub. Date: Jun. 14, 2018

(54) CONTAINER DEPLOYMENT SCHEDULING WITH CONSTANT TIME REJECTION REQUEST FILTERING

(71) Applicant: Red Hat, Inc., Raleigh, NC (US)

(72) Inventors: Jay Vyas, Concord, MA (US); Huamin Chen, Westborough, MA (US); Timothy Charles St. Clair, Middleton, WI (US)

(21) Appl. No.: 15/377,174

(22) Filed: Dec. 13, 2016

(51) Int. Cl. H04L 29/08; H04L 12/911; H04L 12/743; H04L 29/12; G06F 9/48; G06F 9/50

(52) U.S. Cl. CPC H04L 67/32; H04L 47/82; G06F 9/5027; H04L 61/2007; G06F 9/4881; H04L 45/7453

(57) ABSTRACT

Container deployment scheduling with constant time rejection request filtering is disclosed. For example, each node in a multi-node system includes system resources with available amounts quantitatively represented by values. An amplified label set with multiple labels representing each node is created. Labels are generated for first and second nodes, each label representing a system resource and a searchable value of the system resource of a node, searchable values being less than or equal to the value of the respective system resource. A hash value is generated for each label creating a hash filter. A scheduler filter receives a request to launch an isolated guest then generates a new hash value of system resource requirements of the isolated guest to query the hash filter thereby determining whether to submit the request to a scheduler based on a match between the new hash value and a hash value of the hash filter.

### BACKGROUND

The present disclosure generally relates to deploying isolated guests in a network environment. In computer systems, it may be advantageous to scale application deployments by using isolated guests such as virtual machines and containers that may be used for creating hosting environments for running application programs. Typically, isolated guests such as containers and virtual machines may be launched to provide extra compute capacity of a type that the isolated guest is designed to provide. Isolated guests allow a programmer to quickly scale the deployment of applications to the volume of traffic requesting the applications. Isolated guests may be deployed in a variety of hardware environments. There may be economies of scale in deploying hardware in a large scale. To attempt to maximize the usage of computer hardware through parallel processing using virtualization, it may be advantageous to maximize the density of isolated guests in a given hardware environment, for example, in a multi-tenant cloud. In many cases, containers may be leaner than virtual machines because a container may be operable without a full copy of an independent operating system, and may thus result in higher compute density and more efficient use of physical hardware. Multiple containers may also be clustered together to perform a more complex function than the containers are capable of performing individually. A scheduler may be implemented to allocate containers and clusters of containers to a host node, the host node being either a physical host or a virtual host such as a virtual machine.

### SUMMARY

The present disclosure provides a new and innovative system, methods and apparatus for container deployment scheduling with constant time rejection request filtering. In an example, a system includes a plurality of nodes, each node which includes a plurality of system resources respectively associated with a plurality of values, each respective value of the plurality of values quantitatively representing an available amount of each respective system resource of the plurality of system resources. The plurality of nodes includes a first node with a first system resource associated with a first value and a second node with a second system resource associated with a second value. An orchestrator executing on the one or more processors includes a scheduler filter and a scheduler. The scheduler filter creates an amplified label set representing the plurality of nodes, where each node of the plurality of nodes is represented by a respective plurality of labels in the amplified label set. The amplified label set is created by generating a first plurality of searchable values associated with the first system resource, where each searchable value of the first plurality of searchable values is equal to or less than the first value. A first plurality of labels associated with the first node is then generated where each label of the first plurality of labels is different from each other label of the first plurality of labels, each label of the first plurality of labels representing at least the first system resource and a searchable value of the first plurality of searchable values. A second plurality of searchable values associated with the second system resource is then generated where each searchable value of the second plurality of searchable values is equal to or less than the second value. A second plurality of labels associated with the second node is then generated where each label of the second plurality of labels is different from each other label of the second plurality of labels, each label of the second plurality of labels representing at least the second system resource and a searchable value of the second plurality of searchable values.

With the amplified label set, the scheduler filter creates a hash filter by generating a hash value of each label in the amplified label set, including at least a first hash value and a second hash value. The scheduler filter receives a request to launch an isolated guest with a plurality of system resource requirements and creates a third hash value of the plurality of system resource requirements by hashing the plurality of system resource requirements. The hash filter is queried with the third hash value, and the scheduler filter determines whether to submit the request to the scheduler based on whether the third hash value matches at least one hash value in the hash filter. Responsive to determining a match for the third hash value in the hash filter, the request is submitted to the scheduler.

Additional features and advantages of the disclosed method and apparatus are described in, and will be apparent from, the following Detailed Description and the Figures.

### BRIEF DESCRIPTION OF THE FIGURES

FIG. 1 is a block diagram of a system scheduling container deployments with constant time rejection request filtering according to an example of the present disclosure.

FIG. 2 is a block diagram of an example data structure for a constant time request filter according to an example of the present disclosure.

FIG. 3 is a flowchart illustrating an example of scheduling container deployments with constant time rejection request filtering according to an example of the present disclosure.

FIG. 4 is a flow diagram illustrating an example system scheduling container deployments with constant time rejection request filtering according to an example of the present disclosure.

FIG. 5 is a block diagram of an example system scheduling container deployments with constant time rejection request filtering according to an example of the present disclosure.

### DETAILED DESCRIPTION OF EXAMPLE EMBODIMENTS

In computer systems utilizing isolated guests, typically, virtual machines and/or containers are used. In an example, a virtual machine (“VM”) may be a robust simulation of an actual physical computer system utilizing a hypervisor to allocate physical resources to the virtual machine. In some examples, container based virtualization system such as Red Hat® OpenShift® or Docker® may be advantageous as container based virtualization systems may be lighter weight than systems using virtual machines with hypervisors. In the case of containers, oftentimes a container will be hosted on a physical host or virtual machine that already has an operating system executing, and the container may be hosted on the operating system of the physical host or VM. To operate, these isolated guests need to have system resources allocated to them, for example, central processing unit “CPU” or “processor” (cores or shares), Graphics Processing Unit “GPU” (cores or slices), memory (size and I/O rates), persistent storage (size and I/O rates), network bandwidth, IP addresses, network routes, etc. In large scale implementations, container schedulers, for example container orchestrators such as Kubernetes, generally respond to frequent container startups and cleanups with low latency. System resources are generally allocated before isolated guests start up and released for re-use after isolated guests exit. Containers may allow wide spread, parallel deployment of computing power for specific tasks.

Due to economies of scale, containers tend to be more advantageous in large scale hardware deployments where the relatively fast ramp-up time of containers allows for more flexibility for many different types of applications to share computing time on the same physical hardware, for example, in a private or multi-tenant cloud environment. In some examples, where containers from a homogenous source are deployed, it may be advantageous to deploy containers directly on physical hosts. In a multi-tenant cloud, it may be advantageous to deploy containers and groups of containers within virtual machines as the hosting service may not typically be able to predict dependencies for the containers such as shared operating systems, and therefore, using virtual machines adds flexibility for deploying containers from a variety of sources on the same physical host. However, as environments get larger, the number of possible host nodes such as physical servers and VMs grows, resulting in an ever larger number of possible destinations for a scheduler responsible for deploying new containers to search through for an appropriate host for a new container. A user unfamiliar with the common characteristics of hosting nodes in a given environment acting ignorantly or negligently, or a user acting maliciously may repeatedly request nodes with system resource requirements that are unavailable in the environment. In an example, a scheduler may search through the numerous nodes in an environment, comparing available system resources in the nodes to the system resource requirements of the new node systematically before returning a result that the request cannot be fulfilled. If numerous unfulfillable requests are queued, the scheduler may build up a backlog of queries resulting in a denial of service for other users or systems requesting a node for a new container or group of containers.

In an example, rejecting a request by comparing system resource requirements of the request to the available system resource amounts of a plurality of nodes may entail comparing each system resource requirement to a respective system resource amount of each node. In another example, a constant time operation may require only a handful of comparisons to determine whether an exact match for a certain input (e.g., system resource requirements) exists in a set (e.g., available system resources amounts of nodes). In an example, a scheduler managing 1000 nodes may find a node to host a container on average by searching through 500 of the 1000 entries if the new container is capable of being successfully hosted by one of the 1000 hosts. However, if there is no node that may host the new container, the scheduler may need to traverse and compare all 1000 nodes to the newly requested container's system resource requirements before the scheduler may reject the request.

The present disclosure aims to address the above deficiencies, for example relating to queuing requests awaiting determination regarding whether the requests are capable of being fulfilled by practicing container deployment scheduling with constant time rejection request filtering. In an example where the question of “whether the system resource requirements of the requested container may possibly be fulfilled by a node in the environment” may first be answered, the search time of the scheduler for an appropriate container may on average be effectively cut in half by eliminating unfulfillable requests from the scheduler queue. A scheduler filter that first answers this question before submitting a request to the scheduler may then greatly enhance the allocation speed of new containers while preventing denial of service events resulting from a backlog of unfulfillable requests being queued by a scheduler. By using a constant time operation to eliminate unfulfillable requests, a scheduler filter may quickly, efficiently and reliably determine whether a request is possibly fulfillable. In an example, a constant time operation may be any operation where the time required to complete the operation is independent of the input size. For example, accessing a specific, bookmarked page in a book is a constant time operation, while scanning each page of the same book to find a phrase on the bookmarked page depends on the size of the text fragment being scanned for. In an example, utilizing the bookmark may be a much faster operation than scanning for the phrase.

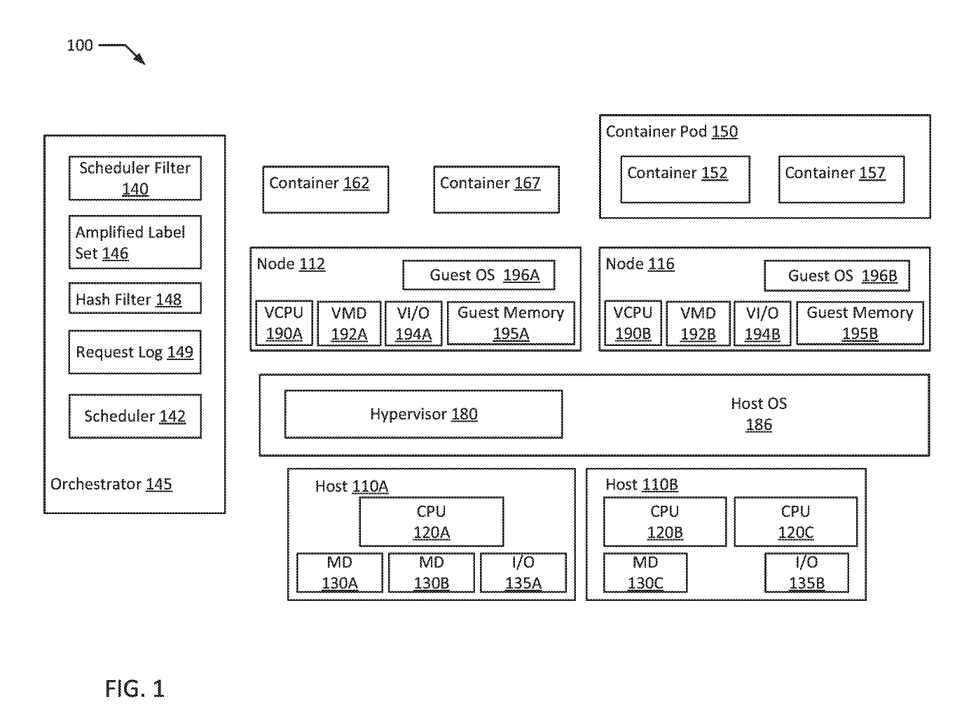

FIG. 1 is a block diagram of a system scheduling container deployments with constant time rejection request filtering according to an example of the present disclosure. The system 100 may include one or more interconnected hosts 110A-B. Each host 110A-B may in turn include one or more physical processors (e.g., CPU 120A-C) communicatively coupled to memory devices (e.g., MD 130A-C) and input/output devices (e.g., I/O 135A-B). As used herein, physical processor or processors 120A-C refers to a device capable of executing instructions encoding arithmetic, logical, and/or I/O operations. In one illustrative example, a processor may follow Von Neumann architectural model and may include an arithmetic logic unit (ALU), a control unit, and a plurality of registers. In an example, a processor may be a single core processor which is typically capable of executing one instruction at a time (or process a single pipeline of instructions), or a multi-core processor which may simultaneously execute multiple instructions. In another example, a processor may be implemented as a single integrated circuit, two or more integrated circuits, or may be a component of a multi-chip module (e.g., in which individual microprocessor dies are included in a single integrated circuit package and hence share a single socket). A processor may also be referred to as a central processing unit (CPU).

As discussed herein, a memory device 130A-C refers to a volatile or non-volatile memory device, such as RAM, ROM, EEPROM, or any other device capable of storing data. As discussed herein, I/O device 135A-B refers to a device capable of providing an interface between one or more processor pins and an external device, the operation of which is based on the processor inputting and/or outputting binary data. Processors (Central Processing Units “CPUs”) 120A-C may be interconnected using a variety of techniques, ranging from a point-to-point processor interconnect, to a system area network, such as an Ethernet-based network. Local connections within each host 110A-B, including the connections between a processor 120A and a memory device 130A-B and between a processor 120A and an I/O device 135A may be provided by one or more local buses of suitable architecture, for example, peripheral component interconnect (PCI).

In an example, system 100 may run one or more isolated guests, for example, containers 152, 157, 162, and 167 may all be isolated guests. In an example, any one of containers 152, 157, 162, and 167 may be a container using any form of operating system level virtualization, for example, Red Hat® OpenShift®, Docker® containers, chroot, Linux®-VServer, Solaris® Containers (Zones), FreeBSD® Jails, HP-UX® Containers (SRP), VMware ThinApp®, etc. Containers may run directly on a host operating system or run within another layer of virtualization, for example, in a virtual machine. In an example, containers 152 and 157 are part of a container pod 150, such as a Kubernetes pod. In an example, containers that perform a unified function may be grouped together in a cluster that may be deployed together. (e.g., in a Kubernetes® pod). In an example, containers 152 and 157 may belong to the same Kubernetes® pod or cluster in another container clustering technology. In an example, containers belonging to the same cluster may be deployed simultaneously by a scheduler 142, with priority given to launching the containers from the same pod on the same node. In an example, a request to deploy an isolated guest may be a request to deploy a cluster of containers such as a Kubernetes® pod. In an example, containers 152 and 157 may be executing on node 116 and containers 162 and 167 may be executing on node 112. In another example, the containers 152, 157, 162, and 167 may be executing directly on hosts 110A-B without a virtualized layer in between.

System 100 may run one or more nodes 112 and 116, which may be virtual machines, by executing a software layer (e.g., hypervisor 180) above the hardware and below the nodes 112 and 116, as schematically shown in FIG. 1. In an example, the hypervisor 180 may be a component of the host operating system 186 executed by the system 100. In another example, the hypervisor 180 may be provided by an application running on the operating system 186, or may run directly on the hosts 110A-B without an operating system beneath it. The hypervisor 180 may virtualize the physical layer, including processors, memory, and I/O devices, and present this virtualization to nodes 112 and 116 as devices, including virtual processors 190A-B, virtual memory devices 192A-B, virtual I/O devices 194A-B, and/or guest memory 195A-B.

In an example, a node 112 may be a virtual machine and may execute a guest operating system 196A which may utilize the underlying virtual central processing unit (“VCPU”) 190A, virtual memory device (“VMD”) 192A, and virtual input/output (“VI/O”) devices 194A. One or more containers 162 and 167 may be running on a node 112 under the respective guest operating system 196A. Processor virtualization may be implemented by the hypervisor 180 scheduling time slots on one or more physical processors 120A-C such that from the guest operating system's perspective those time slots are scheduled on a virtual processor 190A.

A node 112 may run on any type of dependent, independent, compatible, and/or incompatible applications on the underlying hardware and OS 186. In an example, containers 162 and 167 running on node 112 may be dependent on the underlying hardware and/or OS 186. In another example, containers 162 and 167 running on node 112 may be independent of the underlying hardware and/or OS 186. Additionally, containers 162 and 167 running on node 112 may be compatible with the underlying hardware and/or OS 186. In an example, containers 162 and 167 running on node 112 may be incompatible with the underlying hardware and/or OS. In an example, a device may be implemented as a node 112. The hypervisor 180 manages memory for the host operating system 186 as well as memory allocated to the node 112 and guest operating systems 196A such as guest memory 195A provided to guest OS 196. In an example, node 116 may be another virtual machine similar in configuration to node 112, with VCPU 190B, VMD 192B, VI/O 194B, guest memory 195B, and guest OS 196B operating in similar roles to their respective counterparts in node 112. The node 116 may host container pod 150 including containers 152 and 157.

In an example, orchestrator 145 may be a container orchestrator such as Kubernetes® or Docker Swarm®. In the example, orchestrator 145 may be in communication with both hosts 110A-B. In an example, orchestrator 145 may include a scheduler 142 for verifying the capacity of a node (e.g., node 112 or node 116) to host a container (e.g., container 152, container 157, container 162, or container 167) or a container pod (e.g., container pod 150). In an example, the scheduler 142 may also load image files to a node (e.g., node 112 or node 116) for the node (e.g., node 112 or node 116) to launch a container (e.g., container 152, container 157, container 162, or container 167) or container pod (e.g., container pod 150). In an example, a scheduler filter 140 may filter requests from reaching the scheduler 142, only allowing requests that may possibly be fulfilled through to scheduler 142 for verification. In an example, scheduler filter 140 may generate amplified label set 146 and hash filter 148 to facilitate its ability to filter requests for new containers intended for scheduler 142. In an example, request log 149 may be a file or database storing requests for new containers.

In an example, the amplified label set 146, hash filter 148, and/or request log 149 may be stored in any suitable type of database, for example a relational database. The amplified label set 146, hash filter 148, and/or request log 149 may be stored in a database associated with a database management system (DBMS). A DBMS is a software application that facilitates interaction between the database and other components of the system 100. For example, a DMBS may have an associated data definition language describing commands that may be executed to interact with the database. Examples of suitable DMBS's include MariaDB®, PostgreSQL®, SQLite®, Microsoft SQL Server® available from MICROSOFT® CORPORATION, various DBMS's available from ORACLE® CORPORATION, various DBMS's available from SAP® AG, IBM® DB2®, available from the INTERNATIONAL BUSINESS MACHINES CORPORATION, etc. In an example, the amplified label set 146, hash filter 148, and/or request log 149 may be stored in a database organized as a formal database with a schema such as a relational schema with defined tables, indices, links, triggers, various commands etc. In some examples, the amplified label set 146, hash filter 148, and/or request log 149 may not be organized as a formal database, but may instead be an alternative storage structure capable of holding the information stored in the amplified label set 146, hash filter 148, and/or request log 149, including but not limited to a file, folder, directory, registry, etc. In an example, the hash filter 148 may include hash keys or values stored in an array. In some examples, orchestrator 145, host 110A and host 110B may reside over a network from each other, which may be, for example, a public network (e.g., the Internet), a private network (e.g., a local area network (LAN) or wide area network (WAN)), or a combination thereof. In some examples, the amplified label set 146, hash filter 148, and/or request log 149 may be located over a network from the rest of the components of orchestrator 145.

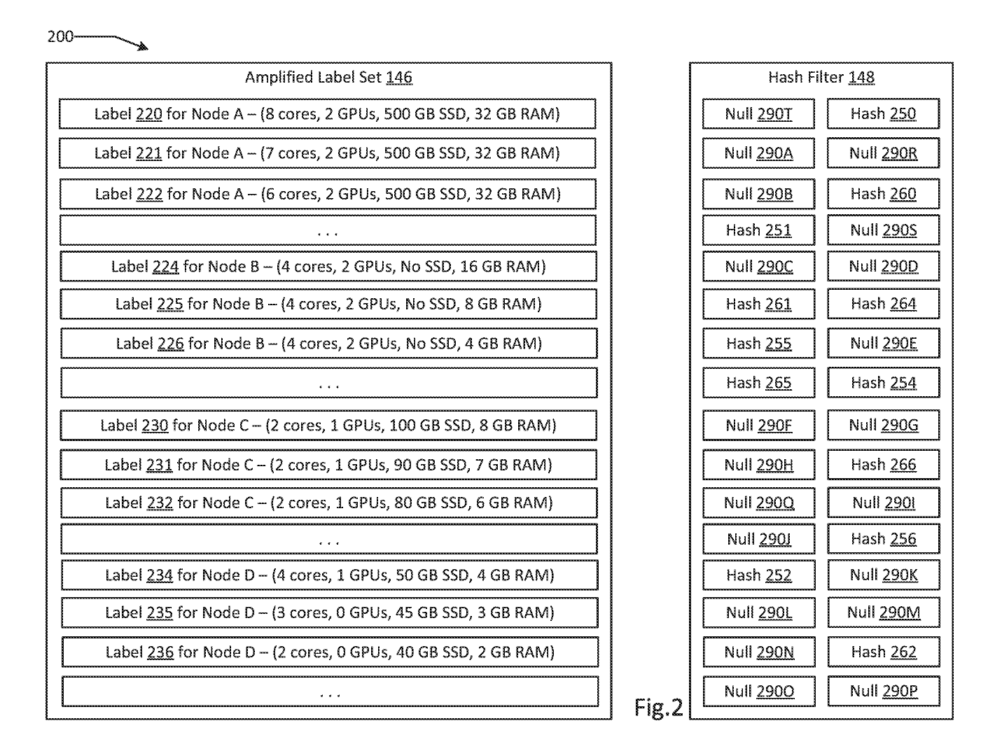

FIG. 2 is a block diagram of an example data structure 200 for a constant time request filter according to an example of the present disclosure. In an example, amplified label set 146 may be stored in any accessible format. In an example, amplified label set 146 may include a plurality of labels representing different nodes in a system. In an example, amplified label set 146 may include multiple labels (e.g., labels 220, 221, 222, 224, 225, 226, 230, 231, 232, 234, 235, and 236) representing each node in a system, where each label (e.g., labels 220, 221, 222, 224, 225, 226, 230, 231, 232, 234, 235, and 236) represents either all of the system resources available to a specific node, or a subset of the system resources available to the specific node. In an example, a first node A may be represented by a plurality of labels including labels 220, 221 and 222. In the example, label 220 may represent the full value of the system resources available to node A, for example, 8 CPU cores, 2 GPU cores, 500 gigabytes (GB) of solid state drive (SSD) storage, and 32 GB of random access memory (RAM). In the example, label 221 may represent slightly less than the full capacity of node A, representing 7 CPU cores rather than 8 CPU cores, and label 222 may represent a further reduced capacity with 6 CPU cores. In an example, node A may be used to fulfill a request for a container requiring 8 CPU cores, 2 GPU cores, 500 GB SSD, and 32 GB RAM, or a container requiring any subset of these system resources, for example, a container requiring 6 CPU cores, 2 GPU cores, 500 GB SSD, and 32 GB RAM. In an example, the amplified label set 146 may further include additional labels for node A where the total system resources available to node A are further systematically reduced to represent a capacity to host a less resource intensive container or container pod in node A.

In an example, amplified label set 146 includes label 224 representing the full capacity of node B, for example, 4 CPU cores, 2 GPU cores, no SSD, and 16 GB RAM, and also label 225 and label 226 representing subsets of node B's total capacity. In an example, labels 224, 225, and 226 may represent node B's lack of an SSD with a 0 GB SSD. In another example, labels 224, 225, and 226 may represent node B's lack of an SSD with a null value for SSD. In an example, amplified label set 146 further includes label 230 representing the full capacity of node C, for example, 2 CPU cores, 1 GPU core, 100 GB SSD, and 8 GB RAM, with label 231 and label 232 representing subsets of node C's total capacity. In an example, amplified label set 146 further includes label 234 representing the full capacity of node D, for example, 4 CPU cores, 1 GPU core, 50 GB SSD, and 4 GB RAM, with label 235 and label 236 representing subsets of node D's total capacity. In an example, amplified label set 146 may include further labels representing subsets of the capacities of nodes A-D respectively. In an example, amplified label set 146 may include more fields for system resources of nodes A-D (e.g., memory I/O rates, persistent storage I/O rates, network bandwidth, IP addresses, network routes, etc.). In another example, amplified label set 146 may include fewer fields for system resource values, (e.g., only CPU cores and RAM size). In an example, the numerical values for representing subsets of the capacities of each system resource of nodes A-D represented by labels 220, 221, 222, 224, 225, 226, 230, 231, 232, 234, 235, and 236 may be more or less granular (e.g., decreasing by 1 GB of RAM at a time vs. decreasing by 0.5 GB of RAM at a time). In an example, higher granularity equates to a larger table for the amplified label set 146 with more labels and rows. In an example, the granularity of the increments of the searchable values of labels 220, 221, 222, 224, 225, 226, 230, 231, 232, 234, 235, and 236 is user configurable. In an example, the granularity of the increments of the searchable values of labels 220, 221, 222, 224, 225, 226, 230, 231, 232, 234, 235, and 236 is balanced against the size of the resulting amplified label set 146, for example, for performance reasons.

The labels 220, 221, 222, 224, 225, 226, 230, 231, 232, 234, 235, and 236 in amplified label set 146 may be the inputs to one or more hash functions to populate hash filter 148. In an example, any type of hash function may be used to convert a label (e.g., labels 220, 221, 222, 224, 225, 226, 230, 231, 232, 234, 235, and 236) to a hash value (e.g., hash values 250, 251, 252, 254, 255, 256, 260, 261, 262, 264, 265, and 266). For example, a checksum (e.g., BSD checksum, checksum, sum, fletcher's checksum, etc.), a universal hash function (e.g., Zobrist hashing, universal one-way hash function, etc.), non-cryptographic hash function (e.g., Pearson hashing, Fowler-Noll-Vo hash function (“FNV Hash”), Jenkins hash function, Java hashcode etc.), keyed cryptographic hash function (e.g., hash based message authentication code (“MAC”), etc.), unkeyed cryptographic hash function (e.g., Message-Digest Algorithms (MD2, MD4, MD5, MD6), SHA-0, SHA-1, SHA-2, SHA-3, etc.), or any other type of function that may map data of an arbitrary size to data of a fixed size may be used to convert a label (e.g., labels 220, 221, 222, 224, 225, 226, 230, 231, 232, 234, 235, and 236) to a hash value (e.g., hash values 250, 251, 252, 254, 255, 256, 260, 261, 262, 264, 265, and 266).

In an example, the hash filter 148 may include a hash table with a set size. For example, the hash filter 148 may have a set number of entries defined when the hash filter 148 is created. In the example, null values (e.g., Null 290A-T) are replaced by hash values (e.g., hash values 250, 251, 252, 254, 255, 256, 260, 261, 262, 264, 265, and 266) as more labels (e.g., labels 220, 221, 222, 224, 225, 226, 230, 231, 232, 234, 235, and 236) are added to the amplified label set 146 and converted to hash values (e.g., hash values 250, 251, 252, 254, 255, 256, 260, 261, 262, 264, 265, and 266) using a hash function. In an example, a particular label may have the same hash value as another label when passed through a given hash function. The likelihood of overlapping hash values within the same hash table may be proportionately related to the size of the hash table and each hash value stored in the hash table. In an example, a hash table may be optimized for speed of lookup and storage size versus the likelihood of a collision where two inputs result in the same hash value. In an example, a hash value may be used as an index for additional data. In an example, a particular hash value used as an index value may be a reference to a data field including multiple pieces of data, for example, multiple labels or references to nodes.

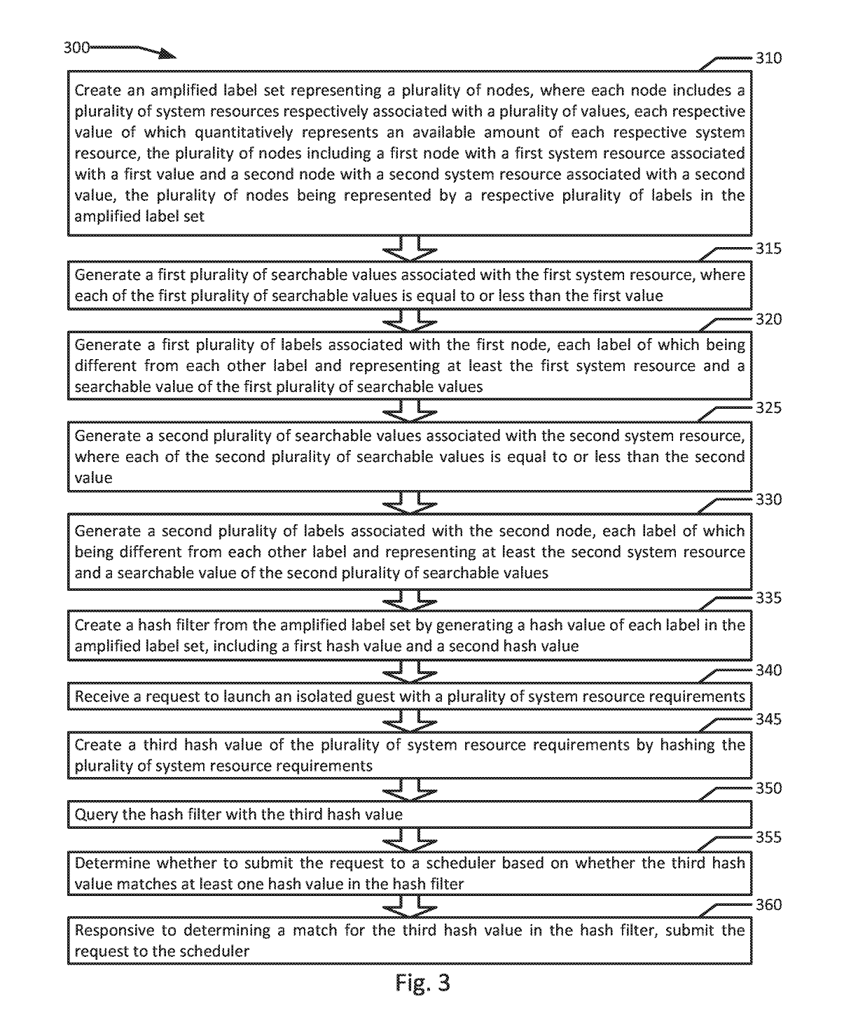

FIG. 3 is a flowchart illustrating an example of scheduling container deployments with constant time rejection request filtering according to an example of the present disclosure. Although the example method 300 is described with reference to the flowchart illustrated in FIG. 3, it will be appreciated that many other methods of performing the acts associated with the method 300 may be used. For example, the order of some of the blocks may be changed, certain blocks may be combined with other blocks, and some of the blocks described are optional. The method 300 may be performed by processing logic that may comprise hardware (circuitry, dedicated logic, etc.), software, or a combination of both. In an example, the method is performed by scheduler filter 140 operating in conjunction with scheduler 142.

An amplified label set representing a plurality of nodes is created, where each node of the plurality of nodes includes a plurality of system resources respectively associated with a plurality of values, each respective value of the plurality of values quantitatively representing an available amount of each respective system resource of the plurality of system resources, the plurality of nodes including a first node with a first system resource associated with a first value and a second node with a second system resource associated with a second value, the plurality of nodes being represented by a respective plurality of labels in the amplified label set (block 310). In an example, scheduler filter 140 creates amplified label set 146, which represents node 112 and node 116 along with their associated system resources (e.g., VCPU 190A-B, VMD 192A-B, VI/O 194A-B, and guest memory 194A-B). In an example, node 112 and node 116 may both execute on host 110A. In another example, node 112 may execute on host 110A and node 116 may execute on host 110B. In an example, node 112 may be separated from node 116 by a network. In an example, the amplified data set 146 may be hosted on the same system hosting scheduler 140. In another example, the amplified data set 146 may be hosted remotely from scheduler 140, for example, on host 110A, host 110B, node 112, node 116, container 162, container 167, container 152, container 157, or some other remote storage location.

The amplified data set may be created by first generating a first plurality of searchable values associated with the first system resource, where each searchable value of the first plurality of searchable values is equal to or less than the first value (block 315). In an example, scheduler filter 140 may generate a number of searchable values associated with a value of the number of cores in VCPU 190A. In an example where VCPU 190A has 4 cores, the value for processor cores in node 112 may be 4, and searchable values for processor cores in node 112 may be 4, 3, 2, and 1. In an example, additional searchable values may be generated for the value of another system resource associated with node 112, for example, VMD 192A may include 8 GB of RAM, and searchable values of 8, 7, 6, 5, 4, 3, 2, and 1 may be generated for the size of RAM in node 112. Additional searchable values may be generated for additional system resources such as persistent storage volume or speed, GPU cores, network bandwidth etc. In an example, the granularity of searchable values may be varied. For example, higher granularity for VMD 192A may result in a lower increment between searchable values resulting in searchable values of 8, 7.5, 7, 6.5, 6, 5.5, 5, 4.5, 4, 3.5, 3, 2.5, 2, 1.5, 1, 0.5, while lower granularity may result in a higher increment between searchable values resulting in searchable values of 8, 6, 4, and 2.

A first plurality of labels associated with the first node may then be generated, where each label of the first plurality of labels is different from each other label of the first plurality of labels, each label representing at least the first system resource and a searchable value of the first plurality of searchable values (block 320). In an example, a set of labels for node 112 may be generated analogous to labels 220, 221, 222, 224, 225, 226, 230, 231, 232, 234, 235, and 236 by scheduler 140. In an example, the scheduler 140 may generate an amplified label set 146 with only two types of system resources represented, processor cores and memory size for node 112, which in the example may have 4 processor cores and 8 GB of RAM. In the example, a total of 32 labels may be generated for node 112 if the granularity of searchable values is delineated in increments of 1 core and 1 GB of RAM (e.g., 4 cores, 8 GB RAM; 3 cores, 8 GB RAM; 2 cores, 8 GB RAM; . . . 4 cores, 7 GB RAM; 3 cores, 7 GB RAM; 2 cores, 7 GB RAM; . . . 4 cores, 6 GB RAM; 3 cores, 6 GB RAM; 2 cores, 6 GB RAM . . . etc.). In another example, 64 labels may be generated for node 112 if the granularity of searchable values is delineated in increments of 1 core and 0.5 GB of RAM. In an example, the scheduler 140 may generate an amplified label set 146 with 4 types of system resources. For example, the scheduler 140 may generate an amplified label set 146 including searchable values for CPU cores, GB of RAM, GB of SSD storage, and GPU cores for node 112 which may, for example, have 4 processor cores, 8 GB of RAM, 500 GB of SSD storage, and 2 GPU cores. In an example where the granularity of searchable values delineated in increments of (i) 1 processor core, (ii) 1 GB of RAM, (iii) 10 GB of SSD, and (iv) 1 GPU core, then 4,896 labels may be generated for node 112 in examples where 0 GB of SSD and 0 GPU cores are valid request values. In an example, scheduler filter 140 may be configured to optimize the granularity of searchable values versus the size and performance of the amplified data set. In a typical example, 0 CPU cores and/or 0 GB of RAM would be impractical for an operational node, and thus may not be valid searchable values. In an example, the types of system resources represented in amplified label set 146 may be determined based on the frequency a particular type of system resource is specifically requested by a new container. In the example, if requests rarely specify a need for GPU cores, GPU cores may not be included in the generation of amplified label set 146.

A second plurality of searchable values associated with the second system resource is generated, where each searchable value of the second plurality of searchable values is equal to or less than the second value (block 325). In an example, scheduler filter 140 may generate a number of searchable values associated with a value of the number of cores in VCPU 190B. In an example where VCPU 190B has 8 processor cores, and therefore the node 116 has a value of 8 for processor cores, the scheduler filter may generate searchable values with the same granularity as used for the value of cores for VCPU 190A, thereby resulting in searchable values of 8, 7, 6, 5, 4, 3, 2, and 1 for processor cores in node 116. In another example, the scheduler filter 140 may use a different granularity for searchable values for VCPU 190B versus VCPU 190A. For example, a granularity of searchable values delineated in increments of 2 cores may be used resulting in searchable values of 8, 6, 4, and 2 cores. In an example, the scheduler filter 140 may be configured to limit the number of searchable values for a given type of system resource to limit the combinations of labels generated. For example, a configuration utility for the scheduler filter 140 may have limited choices for the granularity of searchable values for each type of system resource presented in, for example, a drop down menu.

A second plurality of labels associated with the second node is generated, where each label of the second plurality of labels is different from each other label of the second plurality of labels, each label representing at least the second system resource and a searchable value of the second plurality of searchable values (block 330). In an example, the scheduler filter 140 may generate an amplified label set 146 with only two types of system resources represented, processor cores and memory size for node 116, which in the example may have 8 processor cores and 8 GB of RAM. In the example, a total of 64 labels may be generated for node 116 if the granularity of searchable values is delineated in increments of 1 core and 1 GB of RAM (e.g., 8 cores, 8 GB RAM; 7 cores, 8 GB RAM; 6 cores, 8 GB RAM; . . . 8 cores, 7 GB RAM; 7 cores, 7 GB RAM; 6 cores, 7 GB RAM; . . . 8 cores, 6 GB RAM; 7 cores, 6 GB RAM; 6 cores, 6 GB RAM . . . etc.). In another example, 128 labels may be generated for node 116 if the granularity of searchable values is delineated in increments of 1 core and 0.5 GB of RAM. In an example, the scheduler 140 may generate an amplified label set 146 with 4 types of system resources. For example, the scheduler 140 may generate an amplified label set 146 including searchable values for CPU cores, GB of RAM, GB of SSD storage, and GPU cores for node 116 which may, for example, have 8 processor cores, 8 GB of RAM, 200 GB of SSD storage, and 1 GPU core. In an example where the granularity of searchable values for processor cores is delineated in increments of (i) 1 processor core, (ii) 1 GB of RAM, (iii) 10 GB of SSD, and (iv) 1 GPU core, then 2,688 labels may be generated for node 116. In an example, scheduler filter 140 may be configured to optimize the granularity of searchable values versus the size and performance of the amplified data set. In an example, the number of system resource types used to generate labels for node 112 is the same as the number of system resource types used to generate labels for node 116. In an example, the granularity of searchable values of each system resource type used to generate labels for node 112 is the same as the granularity of searchable values of each system resource type used to generate labels for node 116. In an example, the amplified label set 146 may be generated where references to nodes that may generate a given label are stored in a different, associated field from the label. For example, each label generated for node 116 may include a reference to node 116. In an example, if an identical label may be generated for node 116 as for node 112, two labels may be generated in amplified label set 146. In another example, where an identical label may be generated for node 116 as for node 112, only one label may be generated with references to both node 116 and node 112 associated with the label. For example, a label for 1 processor core, 1 GB RAM, 0 GPU cores, and 10 GB SSD may result from searchable values of both a node with 16 processor cores, 32 GB RAM, 8 GPU cores, and 500 GB SSD, as well as by a node with 2 processor cores, 4 GB RAM, 0 GPU cores and 20 GB SSD. In an example, a label for a particular combination of searchable values for a set of system resource types may be created only once in the amplified data set 146, with a reference to both of the possible nodes associated with the label.

A hash filter is created from the amplified label set by generating a hash value of each label in the amplified label set, including at least a first hash value and a second hash value (block 335). In an example, each label in the amplified label set 146 is passed through a hash function to yield a hash value that is then added to hash filter 148. In an example, any type of function that may map data of an arbitrary size to data of a fixed size may be used by the scheduler filter 140 to generate hash values from labels. In an example, the hash filter 148 may be hosted on the same system hosting scheduler 140. In another example, the hash filter 148 may be hosted remotely from scheduler 140, for example, on host 110A, host 110B, node 112, node 116, container 162, container 167, container 152, container 157, a third node executing on hosts 110A-B, another container executing on node 112 or node 116, or some other remote location. In an example, the hash filter 148 may be hosted on the same system as scheduler filter 140 for faster performance and lower latency.

In example system 200, a hash value 250 may be generated for label 220, and a hash value 260 may be generated for label 230 using a first hash function. In an example, the same hash function may generate hash value 250 again when label 236 is input into the system. In an example, the larger the number of entries available in hash filter 148, the less likely it is that two labels may result in the same hash value. In an example, hash filter 148 may store only a Boolean value of yes or no in relation to each hash value (e.g., hash values 250, 251, 252, 254, 255, 256, 260, 261, 262, 264, 265, and 266). For example, a value of yes may be represented by a binary value of 1, while a value of no may be represented by a binary value of 0. In another example, a hash value (e.g., hash values 250, 251, 252, 254, 255, 256, 260, 261, 262, 264, 265, and 266) may be a key used as an index value for additional information, for example, as a key for a label and/or a node whose label results in the hash value when passed through the chosen hash function. In such an example, the hash value 250 may be used to retrieve a list of labels and/or nodes that match the hash value 250 from the hash filter 148, for example, label 220 representing node A and label 236 representing node D. In an example, multiple hash functions may be used to calculate hash values for each label.

A request to launch an isolated guest with a plurality of system resource requirements is received (block 340). In an example, the scheduler filter 140 may receive a request to launch a container requiring 2 processor cores, 1 GPU core, 50 GB of SSD storage and 4 GB of RAM. A third hash value of the plurality of system resource requirements is created by hashing the plurality of system resource requirements (block 345). In an example, the scheduler filter 140 may enter the system resource requirements of the newly requested container (e.g., 2 processor cores, 1 GPU core, 50 GB of SSD storage and 4 GB of RAM) as an input to the same hash function(s) used to generate the hash filter 148 to generate a hash value for the system resource requirements. In an example, the system resource requirements of the newly requested container may be formatted in the same format as the labels in the amplified data set 146 before being input into the selected hash function(s). In an example, a hash function converts a string of characters into a numerical value. In an example, the numerical value output from a hash function may be a hexadecimal value. An example string “2CPU, 1GPU, 50GBSSD, 4GBRAM” may yield a value of “b6b35e2927bbf64298c343c5f9f448ab” when processed using a 32 bit MD5 hash function, while a string “2CPU, 1GPU, 50.0GBSSD, 4GBRAM” may yield a value of “9310d2549c6906129e7b51bdf3151d09” processed using the same function. In an example, very similar inputs into a hash function may result in very different results from the hash function. In an example, format requirements for system resource requests may be enforced by the scheduler filter 140 by limiting the possible inputs (e.g., using drop down menus). In another example, format requirements for system resource requests may be enforced by the scheduler filter 142 by rounding requested system resource values up to the next higher possible searchable value present in the amplified label set 146. In an example, a request to deploy an isolated guest may be a request to deploy a cluster of containers such as a Kubernetes® pod.

The hash filter is queried with the third hash value (block 350). In an example, the hash filter 148 is queried with a hash value (e.g., b6b35e2927bbf64298c343c5f9f448ab) resulting from hashing the system resource requirements for the newly requested container. The scheduler filter determines whether to submit the request to a scheduler based on whether the third hash value matches at least one hash value in the hash filter (block 355). In an example, label 234 representing node D with 4 cores, 1GPU, 50 GB of SSD storage, and 4 GB of RAM may have generated a hash value 264 that is the same hash value (e.g., b6b35e2927bbf64298c343c5f9f448ab) as the hash value of the newly requested container, for example, because the input into the selected hash function(s) was the same for label 234 as for the newly requested container's system resource requirements.

In an example, the hash filter 148 may represent any form of constant time lookup operation that the scheduler filter 140 may use to determine if there is a possibility of a node in the system 100 existing that may satisfy the system resource requirements of the newly requested container. In an example, hash filter 148 may be implemented as a hash lookup table. In such an example, each hash value (e.g., hash values 250, 251, 252, 254, 255, 256, 260, 261, 262, 264, 265, and 266) in hash filter 148 may be an index key corresponding to a data field. For example, label 220 and label 236 may both result in hash value 250. In an example, hash value 250 may be associated with a field that references the inputs to the hash function that resulted in hash value 250 (e.g., label 220 and label 236). In an example, hash value 250 may be associated with a field that indicates the nodes of the labels from the amplified label set that resulted in hash value 250 when input into the hash function (e.g., node A and node D). In such an example, a newly requested container's system resource requirements resulting in hash value 250 when input into the hash function may allow the hash filter 148 to retrieve a list of nodes (e.g., node A and node D) which may possibly satisfy the requested system resource requirements.

In an example, the hash filter 148 may be a Bloom filter, where a query to the hash filter 148 may result in an answer of “maybe” or “definitely no.” In a Bloom filter, each label in the amplified label set 146 may be hashed by one or more hash functions, the hash values generated by the hash functions then being set to an occupied state in the hash filter 148. In an example, a hash lookup may be significantly slower than a Bloom filter due to the larger size of the hash lookup table because the hash lookup table stores substantive information rather than just the “yes” or “no” stored in a Bloom filter for a given hash value. In an example where there is a high rate of collisions, for example, due to many different nodes being able to satisfy the requested system resource requirements, a hash lookup may result in a lengthy retrieved list of possible nodes. In an example, it may be advantageous to generate both a Bloom filter and a hash lookup table, where a request may be first filtered through the Bloom filter to protect against possible denial of service events, and then input into the hash lookup table to generate a list of possible node candidates for hosting a newly requested container.

In an example where one hash function is used to generate hash filter 148, label 220 and label 236 may both result in hash value 250, while label 234 may result in hash value 264. In such an example, if a newly requested container's system resource requirements results in hash value 250 or hash value 264, the hash filter 148 may indicate when queried that it is possible that the system resource requirements for the newly requested container may be satisfied. If the newly requested container's system resource requirements result in a hash value occupied by a null value in hash filter 148 (e.g., null values 290A-T), the hash filter 148 may indicate when queried that it is definitely impossible to satisfy the system resource requirements for the newly requested container. In a further example where hash filter 148 is a Bloom filter generated by inputting each label in amplified label set 146 into two different hash functions, label 220 may result in hash value 250 and hash value 262, label 236 may result in hash value 250 and hash value 255, while label 234 may result in hash value 264 and 255. As a result, hash values 250, 255, 262, and 264 are occupied in the hash filter 148. In such an example, where the system resource requirements of the newly requested container are input into the same two hash functions as the labels 220, 234 and 236 hash values 255 and 264 may be obtained from the hash functions. Upon querying hash filter 148 with hash values 255 and 264, the hash filter 148 may indicate that both hash value 255 and hash value 264 matched hash values in hash filter 148. In an example, based on the matches found for hash value 255 and hash value 264, the scheduler filter 140 and/or the hash filter 148 may determine that a node may be present in system 100 that may satisfy the system resource requirements of the newly requested container.

In another example, the hash values resulting from inputting the newly requested container's system resource requirements may result in hash values 250 and 264. In such an example, the hash filter 148 and/or scheduler filter 140 may still indicate that the request may be satisfiable even though such a result may be a “false positive.” In an example, a “false positive” result may occur in a Bloom filter where hash values used to query the filter match hash values added to the filter by different sources. For example, label 236 may have resulted in hash values 250 and 255, while label 234 may have resulted in has values 255 and 264. In such an example, the hash values of the newly requested container's system resources may match hash value 250 from label 236 and hash value 264 from label 234 resulting in a “false positive.” If instead of hash values 250 and 264, the newly requested container's system resource requirements hashed into hash value 264 and one of null values 290A-T, then the hash filter 148 may indicate when queried that the request was definitely not satisfiable. In an example, the more hash functions each label and query request are hashed with, the less likely it is that a “false positive” may result on the hash value resulting from every hash function used, but at a trade off of speed and size. In an example, the hash filter 148 may need to be increased in size to reduce odds of a “false positive” result as the amplified label set 146 becomes larger. A Bloom filter may be advantageous for answering the question, “is satisfying the request possible” because the Bloom filter is very compact and may thus be stored in RAM for fast access and fast results due to only requiring one bit of storage (0 or 1) for each hash value. By not storing any substantive data and thereby retaining speed and responsiveness, a hash filter 148 configured as a Bloom filter may be well suited to preventing a denial of service type situation due to repeated unsatisfiable requests, because any time a hash value for a newly requested container results in a empty entry in the Bloom filter (e.g., null values 290A-T in hash filter 148), the request for a new container may be immediately rejected by scheduler filter 140 without being forwarded for confirmation to scheduler 142.

Responsive to determining a match for the third hash value in the hash filter, submit the request to the scheduler (block 360). In an example, the scheduler filter 140 may receive a response back from the hash filter 148 that a hash value of the system resource requirements for a newly requested container matches a hash value in the hash filter 148, and the scheduler filter 140 may submit the request to the scheduler 142 to verify that at least one node in the system 100 currently has available system resources for hosting the newly requested container. In an example, the scheduler 142 may determine that a node (e.g., node 112 or node 116) may host the newly requested container and launch the container in node 112. In another example, the scheduler 142 may determine that while node 112 and/or node 116 may host the newly requested container in theory, that node 112 is currently hosting containers 162 and 167 and node 116 is hosting container pod 150 with containers 152 and 157, and therefore lack the current capacity to host the newly requested container. In such an example, the scheduler 142 may reject the request for the newly requested container even though the scheduler filter 140 determined that the request could be satisfied. In an example, the hash function(s) used by the scheduler filter 140 to create the hash filter 148 are not reversible. In an example, to update hash filter 148 to reflect removals of nodes from the system 100, and removal of labels from amplified label set 146, the whole hash filter 148 may generally be regenerated to avoid producing “false negative” results from removing a hash value for an occupied or reclaimed node. In an example, removing a hash value from hash filter 148 may also remove a reference to a valid label sharing the same hash value. In such an example, the hash filter 148 may only be regenerated periodically and may therefore cause the scheduler filter 140 to send some unsatisfiable requests to the scheduler 142 as possibly satisfiable due to aged data. In an example, the hash filter 148 includes a hash lookup table allowing the scheduler filter 140 to send a shortened list of possible node candidates to the scheduler 142 to validate whether the request is satisfiable.

In an example, the scheduler filter 140 limits the number of system resources input into the amplified label set 146, and/or the granularity of the searchable values used to generate the amplified label 146 set to limit the size of the hash filter required to produce a reasonably low rate of false positive results. In an example, the granularity of requested system resource values may be limited, for example, by limiting request submissions for persistent storage to 10 GB increments to match the granularity of the searchable values used to generate the amplified label set 146. In an example, an input value for a system resource requirement for a newly requested container is rounded to the nearest higher searchable value for that system resource before the system resource requirements for the newly requested container are passed into the hash function to allow the request to match the granularity of the amplified label set. In an example, due to the nature of hash functions, a query based on a hash value for system resource requirements of a newly requested container that has improper granularity and/or formatting may result in an invalid result.

In an example, to determine whether a node in the system exists that may satisfy a request for a new container, a scheduler 142 may cycle through a list including the available values of each system resource for each node in the system 100. In an example, the scheduler 142 cycles through the list, a comparison of each value of each system resource of each node may be compared with the respective requested value of the respective system resource in the request, with each node then being sequentially rejected as a mismatch is found. In a system with 1,000 nodes, each with 10 types of system resources and a field for availability, a minimum of 1,000 comparisons (e.g., if every node is unavailable) to a maximum of 11,000 comparisons may be required before a request may be rejected. By implementing a Bloom filter in hash filter 148, the number of comparisons required to reject a request may commonly be reduced to 2-7comparisons (e.g., for acceptable “false positive” rates of 1-10% for 100 to 100,000 possible labels) based on using 2-7 hash functions to generate the hash values in the Bloom filter and for the system resource requirements in the request for a new container. In the example, rejecting unsatisfiable requests is then sped up by several orders of magnitude. For example, a Bloom filter with 100,000 possible hash values for labels and a 1% “false positive” rate may be created in around 100 KB of storage space using 7 different hash functions, an amount that may easily be loaded into RAM and incorporated into a scheduler filter 140. In comparison, a direct comparison by a scheduler 142 of requested resource values to available resource values may require loading a database of nodes and system resources from persistent storage, potentially over a network, resulting in a much slower operation by several orders of magnitude.

In an example, the amplified data set 146 and the hash filter 148 may be periodically regenerated to reflect an updated set of available nodes in the system 100. In an example, occupied nodes may be included the amplified data set 146 during regeneration in case they become available before the next time the amplified data set 146 and the hash filter 148 are regenerated. In an example where the hash filter 148 is regenerated more often, occupied nodes may be ignored to produce less “false positive” results and therefore reject more requests before the requests are forwarded to scheduler 142.

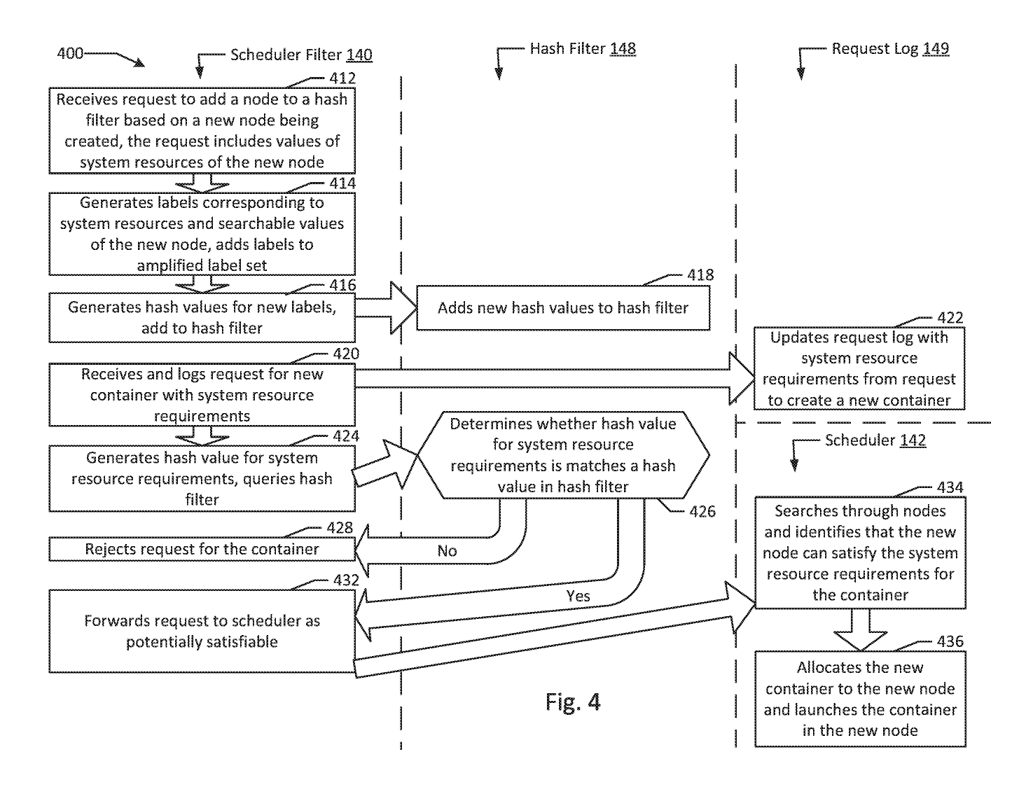

FIG. 4 is a flow diagram illustrating an example system scheduling container deployments with constant time rejection request filtering according to an example of the present disclosure. Although the examples below are described with reference to the flowchart illustrated in FIG. 4, it will be appreciated that many other methods of performing the acts associated with FIG. 4 may be used. For example, the order of some of the blocks may be changed, certain blocks may be combined with other blocks, and some of the blocks described are optional. The methods may be performed by processing logic that may comprise hardware (circuitry, dedicated logic, etc.), software, or a combination of both. In example system 400, a scheduler filter 140 is in communication with a hash filter 148, a request log 149, and a scheduler 142. In an example, the hash filter 148 has been previously created.

In an example, scheduler filter 140 receives a request to add a node to hash filter 148 based on a new node being created in system 100, the request including values of the system resources of the new node (block 412). In the example, a new node (e.g., a new VM or new physical host) may have been made available to the orchestrator 145. For example, a new VM may have been provisioned from hypervisor 180. In an example, the new node may be a pre-existing node that orchestrator 145 previously did not have access to. For example, in a multi-tenant cloud, the new node could be a node that was previously allocated to a different tenant in a situation where orchestrator 145 only provisions containers for a specific tenant or subset of tenants.

In an example, scheduler filter 140 generates labels corresponding to system resources of the new node and searchable values of the new node and adds the labels to the amplified label set 146 (block 414). In an example, the scheduler filter 140 may generate labels representing the new node with searchable values of the same granularity as those used previously to generate the existing amplified label set 146 used to create the hash filter 148. In an example, references associating the new labels with the new node may be made. In an example, scheduler filter 140 may generate hash values for the new labels and add the hash values to the hash filter 148 (block 416). In an example, some of the new hash values may match existing hash values in hash filter 148. In an example, multiple hash functions may be used to generate multiple hash values for each new label. In an example, hash filter 148 may include a constant time rejection filter (e.g., a Bloom filter) and/or a constant time lookup (e.g., a hash lookup table). In an example where hash filter 148 includes constant time lookup functionality, references to the new node may be linked to hash values acting as hash or index keys for the node. In an example, the hash filter 148 adds the new hash values to the hash filter 148 (block 418). In an example, the new hash values may be added in Boolean form (e.g., “yes” or “no”) by changing a Boolean field associated with each respective new hash value from a 0 indicating “no” to a 1 indicating “yes” in hash filter 148 (e.g., in a Bloom filter). In an example, the new hash values may be added including references to the new labels and/or the new node in a hash lookup table in hash filter 148.

In an example Bloom filter, a possible label for a first node may be “2Core, 4GBRAM” and a possible label for a second node may be “4Core, 2GBRAM.” To populate a simple Bloom filter, with only 100 possible hash values stored in an array, 2 hash functions may be used to hash the label for the first node and the label for the second node, generating 4 hash values. In an example, the first label “2Core, 4GBRAM” results in hash values corresponding to the 8^{th} and the 92^{nd} elements of the array, and the 8^{th} and 92^{nd} elements are changed from a 0 to a 1 in the array. Similarly, in the example, the second label “4Core, 2GBRAM” may result in hash values corresponding to the 34^{th} and 88^{th} elements in the array, and the 34^{th} and 88^{th} elements are changed from a 0 to a 1 in the array. A request for a new container may include system requirements of “4Core, 8GBRAM.” In an example, “4Core, 8GBRAM” when hashed using the hash functions results in hash values corresponding to the 34^{th} and 58^{th} elements in the array, and because the 58^{th} element is set to 0, indicating that no hash value of any label corresponded with the 58^{th} element in the array, the Bloom filter may result in a determination that the request is impossible to grant. In another example, where the hash functions return hash values for the request corresponding to the 8^{th} and 88^{th} elements in the array, both hash values would match an element set to 1 in the array resulting in the Bloom filter determining that the request may be grantable. However, such a result would be a “false positive” because the 8^{th} element was set to 1 by the first label while the 88^{th} element was set to 1 by the second label. In an example, as the number of possible hash values increases with the size of the array, and the number of hash functions used is increased, the odds of a “false positive” result decrease because it is less likely that all of the hash values generated for a request using all of the different hash functions specified would result in collisions with existing hash values in the Bloom filter.

In an example, scheduler filter 140 receives and logs a request to create a new container with system resource requirements (block 420). In an example the system resource requirements for the new container may be included in the request for the new container. In another example, the system resource requirements for the new container may be retrieved separately. For example, a request may be for a container based on a certain image file, and the system resource requirements for the specific image file may be retrieved from an image repository including the image file. In an example, the system resource requirements for the new container may be retrieved from metadata associated with the image file. In an example, the request log 149 is updated with the system resource requirements from the request to create a new container (block 422). In an example, each request for a new container may be logged in request log 149. In another example, a limited set of requests may be logged in request log 149. For example, requests rejected by scheduler filter 140 may be logged. In another example, additional information may be logged, for example, requests forwarded to the scheduler 142 where the scheduler filter 140 determined that the request may be satisfiable may be logged. In an example, requests forwarded to scheduler 142 that the scheduler 142 determines cannot be granted may be logged in request log 149, for example, due to all of the nodes with capacity to include a certain container being occupied.

In an example, orchestrator 145 or a subcomponent of orchestrator 145 such as scheduler filter 140 and/or scheduler 142 may parse the data logged in request log 149. In an example, orchestrator 145 may determine that a plurality of requests for new containers requiring 4 GB of RAM have been satisfied with nodes that have 6 GB of RAM available. In an example the remaining 2 GB of RAM in the 6 GB of RAM nodes may be wasted or idle due to the nodes lacking sufficient system resources such as CPU cores to have additional containers assigned to the nodes. In an example, the orchestrator 145 may request that the hypervisor 180 create new nodes with 4 GB of RAM rather than 6 GB of RAM to allow more nodes to be created on the hosts 110A-B. In another example, the orchestrator 145 may request the hypervisor 180 to create new nodes with 8 GB of RAM that may fit two of the containers requiring 4 GB of RAM to increase container density on hosts 110A-B. In an example, more containers may execute on hosts 110A-B after the requested resource realignment by orchestrator 145. In an example, orchestrator 145 may command an application programming interface to adjust the resource allocations in new nodes created in system 110. In an example, an application programming interface for hypervisor 180 or another application programming interface of the compute resource provider (e.g., a private cloud or multi-tenant cloud provider) may be commanded by orchestrator 145 to increase or reduce the allocation of a particular type of system resource in new nodes to allow for higher container density. In an example, orchestrator 145 may request new nodes to be created based on requests that could not be granted. In an example, request log 149 may show a pattern of behavior flagged as suspicious or malicious, for example, a multitude of requests for an irregular and/or un-grantable amount of a particular type of system resource may result in a temporary or permanent suspension of the requestor of such system resources' rights to request new containers. In an example, repeated un-grantable requests may be a sign of a denial of service event. In an example, a denial of service event may be a sign of a malicious act.

In an example, the orchestrator 145 may track trends in requests for new containers over time. For example, the orchestrator 145 may track that requests for containers requiring GPU cores have increased over time, resulting in, for example, an increased proportion of requests requiring GPU cores to be rejected due to a lack of sufficient GPU cores in hosts 110A-B to create sufficient nodes with sufficient GPU cores to satisfy such requests. In an example, GPU cores may have become a limiting system resource causing other system resources of hosts 110A-B to sit idle and unallocated. In an example, orchestrator 145 may flag a pattern that additional GPU cores are required to optimize compute resource allocation. In an example, the orchestrator 145 may notify an administrator to install additional hardware such as GPU cores based on the system resource requirements indicated in the request log 149. In an example, orchestrator 145, specifically scheduler filter 140, hash filter 148 and request log 149 may function as an auto-tuning cloud-scheduling feedback loop that uses constant time rejection of unschedulable resources alongside hypervisor reprovisioning of container hosts to increase container density and decrease latency when requesting new containers.

In an example, scheduler filter 140 generates hash value(s) for the system resource requirements of the newly requested container and queries the hash filter 148 with the hash value(s) (block 424). In an example, the scheduler filter 140 generates hash value(s) for the system resource requirements of the newly requested container with the same hash function(s) used to generate the hash filter 148. In an example, the scheduler filter 140 may round the system resource requirements of the newly requested container up to the nearest value that matches a searchable value of the particular type of system resource based on the granularity of searchable values of the particular type of system resource used when generating the amplified label set 146 used to generate the hash filter 148. In an example where sufficient requests are received for a system resource with a lesser quantity than the next highest searchable value such as for example, requests for 3.3 GB of RAM where the next highest searchable value is 4 GB of RAM, the lesser value may be added as a searchable value outside of the normal granularity progression when the amplified label set 146 is regenerated. In an example, where sufficient quantities of a container requiring 3.3 GB of RAM are found in request log 149, the orchestrator 145 may request the hypervisor 180 to provision new nodes with 3.3 GB of RAM. In an example, a subset of the system resource requirements of the newly requested container may be used to generate the hash value(s) of the request. For example, if the amplified label set 146 was generated with only CPU cores, GB of RAM and GB of SSD, those three types of system resource may be the only types used to generate the hash value(s) for the request to ensure the query to the hash filter 148 is made using the same type of source data used to generate the hash filter 148. In an example, the request for a new container may include less than all of the types of system resources used to generate the amplified label set 148, and a zero or null value may be added to match the requested system resource requirements to the types used to generate the amplified label set 148. For example, a newly requested container may be silent on GPU core needs, where the amplified label set 146 and the resulting hash filter 148 included searchable values for GPU cores. In the example, before being input into the hash function(s), the request may have a 0 GPU cores value added.

In an example, the hash filter 148 determines whether the hash value for the system resource requirements matches a hash value of hash filter 148 (block 426). In an example, hash filter 148 may include a Bloom filter, where the hash value(s) for the system resource requirements of the newly requested container are compared with existing hash values in hash filter 148 and any failure to match by any of the hash value(s) of the system resource requirements may result in a determination of a failed match. In an example, the hash filter 148 may include a hash lookup table where a failure to match a hash value of the hash filter 148 may result in a determination of a failed match. In an example, a hash value of the system resource requirements may match a hash value of the hash filter 148 but, a further determination may be made that the label used to generate the hash value in the hash filter 148 represented different searchable values for the various system resources from the requested amounts of each system resource, and thereby identify the match as a “false positive.” For example, a request for 5 CPU cores and 37 GB of RAM may have resulted in an identical hash value to a label representing 4 CPU cores and 12 GB of RAM. In such an example, the matched hash values would be a “false positive” match. In an example, upon failure to match a hash value in the hash filter 148, the request for a new container is rejected by the scheduler filter 140 (block 428). In an example, the hash value of the system resource requirements may not match any hash value in the hash filter 148 resulting in a rejection of the request for a new container.

In an example, upon determining a valid match between the hash value(s) of the system resource requirements of the request for a new container and hash value(s) of the hash filter 148, the scheduler filter 140 may forward the request to the scheduler 142 as potentially satisfiable (block 432). In an example where the hash filter 148 includes a hash lookup table that is directly queried or only queried after a Bloom filter fails to reject a request, the hash filter 148 may inform the scheduler filter 140 of a list of nodes that may potentially satisfy the request. In an example, the scheduler filter 140 or the hash filter 148 may forward a list of nodes that may potentially satisfy the request to the scheduler 142. In an example, the scheduler 142 searches through the nodes in system 100 and identifies that the new node may satisfy the system resource requirements for the new container (block 434). In an example, the scheduler 142 allocates the new container to the new node and launches the container in the new node (block 436). In another example, the scheduler 142 may determine that all of the nodes in system 100 that may satisfy the system resource requirements of the newly requested container are currently occupied and reject the request, or that all of the nodes in the list of nodes provided by the scheduler filter 140 or the hash filter 148 are currently occupied and reject the request. In an example, the amplified label set 146 and therefore the hash filter 148 may have been generated with a subset of the possible system resource types requested by the new container, and the scheduler 142 may reject the request due to a lack of an available node with sufficient system resources of a type not validated by the hash filter 148.

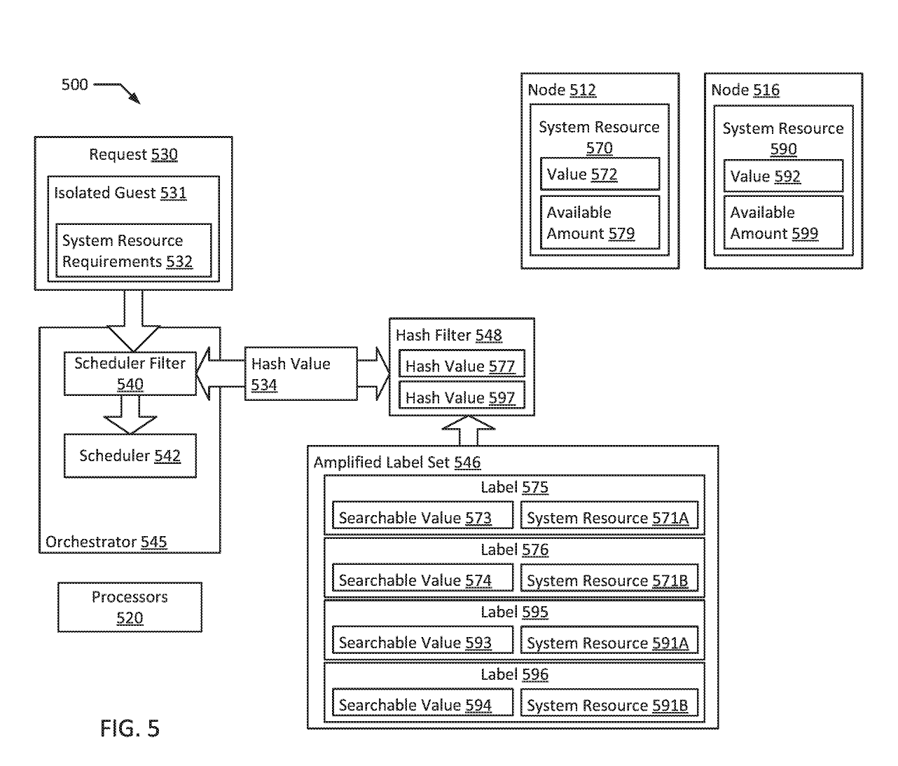

FIG. 5 is a block diagram of an example system scheduling container deployments with constant time rejection request filtering according to an example of the present disclosure. Example system 500 may include a plurality of nodes (e.g., node 512 and node 516), each node (e.g., node 512 and node 516) of which includes a plurality of system resources (e.g., system resource 570 and system resource 590) respectively associated with a plurality of values (e.g., value 572 and value 592), each respective value (e.g., value 572 and value 592) of the plurality of values quantitatively representing an available amount (e.g., available amount 579 and available amount 599) of each respective system resource (e.g., system resource 570 and system resource 590), the plurality of nodes (e.g., node 512 and node 516) including a node 512 with a system resource 570 associated with a value 572 and a node 516 with a system resource 590 associated with a value 599. An orchestrator 545 may execute on one or more processors 520, the orchestrator 545 including a scheduler filter 540 and a scheduler 542.

In an example, the scheduler filter 540 may create an amplified label set 546 representing the plurality of nodes (e.g., node 512 and node 516), where each node (e.g., node 512 and node 516) is represented by a respective plurality of labels (e.g., labels 575, 576, 595 and 596) in the amplified label set 546. The amplified label set 546 may be created by first generating a first plurality of searchable values (e.g., searchable value 573 and searchable value 574) associated with the system resource 570, where each searchable value 573 and searchable value 574 are equal to or less than value 572. In an example, system resource 570 may be the number of CPU cores available to node 512, where value 572 may be a value of 4 indicating that node 512 has 4 CPU cores. In the example, searchable value 573 and searchable value 574 may then be 3 and 2 respectively.

In an example, the amplified label set 546 may continue to be created by generating a first plurality of labels (e.g., label 575 and label 576) associated with node 512, where label 575 is different from label 576. In an example, label 575 represents system resource 571A which may be a reference to system resource 570, and searchable value 573 which may be less than or equal to value 572. In an example, label 576 represents system resource 571B which may be a reference to system resource 570, and searchable value 574 which may be less than or equal to value 572 but different from searchable value 573. In an example, label 575 may represent 3 CPU cores and label 576 may represent 2 CPU cores.

In an example, the amplified label set 546 may continue to be created by generating a second plurality of searchable values (e.g., searchable value 593 and searchable value 594) associated with the system resource 590, where each searchable value 593 and searchable value 594 are equal to or less than value 592. In an example, system resource 590 may be the number of CPU cores available to node 516, where value 592 may be a value of 8 indicating that node 516 has 8 CPU cores. In the example, searchable value 593 and searchable value 594 may then be 7 and 6 respectively.

In an example, the amplified label set 546 may continue to be created by generating a second plurality of labels (e.g., label 595 and label 596) associated with node 516, where label 595 is different from label 596. In an example, label 595 represents system resource 591A which may be a reference to system resource 590, and searchable value 593 which may be less than or equal to value 592. In an example, label 596 represents system resource 591B which may be a reference to system resource 590, and searchable value 594 which may be less than or equal to value 592 but different from searchable value 593. In an example, label 595 may represent 7 CPU cores and label 596 may represent 6 CPU cores.

In an example, the scheduler filter 540 creates a hash filter 548 from the amplified label 546 set by generating a hash value (e.g., hash value 577 and hash value 597) of each label (e.g., labels 575, 576, 595, 596) in the amplified label set 548, including hash value 577 and hash value 597. In an example, the hash value of two labels representing the same amount of the same type of system resource may be equal. In an example, the scheduler filter 540 receives a request 530 to launch an isolated guest 531 with system resource requirements 532. In an example, the scheduler filter 540 may create a hash value 534 of the system resource requirements 532 by hashing the system resource requirements 532. In an example, hash value 534 is calculated with the same hash function as hash value 577 and hash value 597. In an example, system resource requirements 532 are reformatted to be in the same format as labels 575, 576, 595 and 596 prior to generating hash value 534.

In an example, scheduler filter 540 queries the hash filter 548 with hash value 534. In an example, scheduler filter 540 determines whether to submit the request 530 to the scheduler 542 based on whether hash value 534 matches at least one hash value (e.g., hash value 577, hash value 597) in the hash filter 548. In an example, responsive to determining a match (e.g., hash value 534 matching hash value 577) for hash value 534 in the hash filter, the scheduler filter 540 submits the request 530 to the scheduler 542. In an example, the scheduler 542 may determine that node 512 may satisfy the system resource requirements 532 of isolated guest 531 and launch isolated guest 531 in node 512.

It will be appreciated that all of the disclosed methods and procedures described herein can be implemented using one or more computer programs or components. These components may be provided as a series of computer instructions on any conventional computer readable medium or machine readable medium, including volatile or non-volatile memory, such as RAM, ROM, flash memory, magnetic or optical disks, optical memory, or other storage media. The instructions may be provided as software or firmware, and/or may be implemented in whole or in part in hardware components such as ASICs, FPGAs, DSPs or any other similar devices. The instructions may be executed by one or more processors, which when executing the series of computer instructions, performs or facilitates the performance of all or part of the disclosed methods and procedures.

It should be understood that various changes and modifications to the example embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A system comprising:
a plurality of nodes, each node of the plurality of nodes including a plurality of system resources respectively associated with a plurality of values, each respective value of the plurality of values quantitatively representing an available amount of each respective system resource of the plurality of system resources, the plurality of nodes including a first node with a first system resource associated with a first value and a second node with a second system resource associated with a second value;
one or more processors;
an orchestrator executing on the one or more processors including:
a scheduler filter, and
a scheduler,
wherein the scheduler filter:
creates an amplified label set representing the plurality of nodes, wherein each node of the plurality of nodes is represented by a respective plurality of labels in the amplified label set, by:
generating a first plurality of searchable values associated with the first system resource, wherein each searchable value of the first plurality of searchable values is equal to or less than the first value;
generating a first plurality of labels associated with the first node, wherein each label of the first plurality of labels is different from each other label of the first plurality of labels, each label of the first plurality of labels representing at least the first system resource and a searchable value of the first plurality of searchable values;
generating a second plurality of searchable values associated with the second system resource, wherein each searchable value of the second plurality of searchable values is equal to or less than the second value; and
generating a second plurality of labels associated with the second node, wherein each label of the second plurality of labels is different from each other label of the second plurality of labels, each label of the second plurality of labels representing at least the second system resource and a searchable value of the second plurality of searchable values;
creates a hash filter from the amplified label set by generating a hash value of each label in the amplified label set, including at least a first hash value and a second hash value;
receives a request to launch an isolated guest with a plurality of system resource requirements;
creates a third hash value of the plurality of system resource requirements by hashing the plurality of system resource requirements;
queries the hash filter with the third hash value;
determines whether to submit the request to the scheduler based on whether the third hash value matches at least one hash value in the hash filter; and
responsive to determining a match for the third hash value in the hash filter, submitting the request to the scheduler.

2. The system of claim 1, wherein the first node and the second node execute on a single host.

3. The system of claim 1, wherein the first node executes on a first host, and the second node executes on a second host different from the first node.

4. The system of claim 1, wherein the scheduler filter determines that the third hash value is unmatched in the hash filter, and the request to launch the isolated guest is rejected.

5. The system of claim 4, wherein the scheduler filter rejects the request to launch the isolated guest without submitting the request to launch the isolated guest to the scheduler.

6. The system of claim 1, wherein the scheduler filter determines that a first match exists for the third hash value in the hash filter, and
wherein the scheduler determines that all nodes that are represented by the match are currently unavailable and rejects the request to launch the isolated guest.

7. The system of claim 1, wherein each request to launch an isolated guest is logged.

8. The system of claim 7, wherein the scheduler adjusts a requested value of a system resource when requesting creation of a new node in response to system resource requirements included in logged requests.

9. The system of claim 8, wherein more nodes execute on the first host as a result of reducing the requested value of a system resource associated with at least one node executing on the first host based on system resource requirements included in logged requests.

10. The system of claim 8, wherein the scheduler commands an application programming interface to create new nodes.

11. The system of claim 7, wherein the scheduler notifies an administrator to install additional hardware based on system resource requirements included in logged requests.

12. The system of claim 1, wherein the hash filter is hosted on a third node of the plurality of nodes.

13. The system of claim 1, wherein the scheduler filter,
generates a third plurality of searchable values associated with the a third system resource of the first node, wherein the third system resource is associated with a third value, and each searchable value of the third plurality of searchable values is equal to or less than the third value;
generates a third plurality of labels associated with the first node, wherein each label of the third plurality of labels is different from each other label of the third plurality of labels, each label representing at least the third system resource and a searchable value of the third plurality of searchable values.

14. The system of claim 1, wherein at least one node of the plurality of nodes is a virtual machine.

15. A method comprising:
creating an amplified label set representing a plurality of nodes, wherein each node of the plurality of nodes includes a plurality of system resources respectively associated with a plurality of values, each respective value of the plurality of values quantitatively representing an available amount of each respective system resource of the plurality of system resources, the plurality of nodes including a first node with a first system resource associated with a first value and a second node with a second system resource associated with a second value, the plurality of nodes being represented by a respective plurality of labels in the amplified label set, by:
generating a first plurality of searchable values associated with the first system resource, wherein each searchable value of the first plurality of searchable values is equal to or less than the first value;
generating a first plurality of labels associated with the first node, wherein each label of the first plurality of labels is different from each other label of the first plurality of labels, each label representing at least the first system resource and a searchable value of the first plurality of searchable values;
generating a second plurality of searchable values associated with the second system resource, wherein each searchable value of the second plurality of searchable values is equal to or less than the second value; and
generating a second plurality of labels associated with the second node, wherein each label of the second plurality of labels is different from each other label of the second plurality of labels, each label representing at least the second system resource and a searchable value of the second plurality of searchable values;
creating a hash filter from the amplified label set by generating a hash value of each label in the amplified label set, including at least a first hash value and a second hash value;
receiving a request to launch an isolated guest with a plurality of system resource requirements;
creating a third hash value of the plurality of system resource requirements by hashing the plurality of system resource requirements;
querying the hash filter with the third hash value;
determining whether to submit the request to a scheduler based on whether the third hash value matches at least one hash value in the hash filter; and
responsive to determining a match for the third hash value in the hash filter, submitting the request to the scheduler.

16. The method of claim 15, wherein the third hash value is a nonmatching value when compared with each value of each label in the amplified label set in the hash filter, and the request to launch the isolated guest is rejected by a scheduler filter without submitting the request to launch the isolated guest to the scheduler.

17. The method of claim 15, further comprising:
determining that a first match exists for the third hash value in the hash filter, and
determining that all nodes that are represented by the match are currently unavailable; and
rejecting the request to launch the isolated guest.

18. The method of claim 1, wherein each request to launch an isolated guest is logged.

19. The method of claim 18, further comprising:
adjusting a requested value of a system resource when requesting creation of a new node in response to system resource requirements included in logged requests.

20. A computer-readable non-transitory storage medium storing executable instructions, which when executed by a computer system, cause the computer system to:
create an amplified label set representing a plurality of nodes, wherein each node of the plurality of nodes includes a plurality of system resources respectively associated with a plurality of values, each respective value of the plurality of values quantitatively representing an available amount of each respective system resource of the plurality of system resources, the plurality of nodes including a first node with a first system resource associated with a first value and a second node with a second system resource associated with a second value, the plurality of nodes being represented by a respective plurality of labels in the amplified label set, by:
generating a first plurality of searchable values associated with the first system resource, wherein each searchable value of the first plurality of searchable values is equal to or less than the first value;
generating a first plurality of labels associated with the first node, wherein each label of the first plurality of labels is different from each other label of the first plurality of labels, each label representing at least the first system resource and a searchable value of the first plurality of searchable values;
generating a second plurality of searchable values associated with the second system resource, wherein each searchable value of the second plurality of searchable values is equal to or less than the second value; and
generating a second plurality of labels associated with the second node, wherein each label of the second plurality of labels is different from each other label of the second plurality of labels, each label representing at least the second system resource and a searchable value of the second plurality of searchable values;
create a hash filter from the amplified label set by generating a hash value of each label in the amplified label set, including at least a first hash value and a second hash value;
receive a request to launch an isolated guest with a plurality of system resource requirements;
create a third hash value of the plurality of system resource requirements by hashing the plurality of system resource requirements;
query the hash filter with the third hash value;
determine whether to submit the request to the scheduler based on whether the third hash value matches at least one hash value in the hash filter; and
responsive to determining a match for the third hash value in the hash filter, submitting the request to the scheduler.
